(19) United States
(12) Patent Application Publication
(10) Pub. No.: US 2026/0157573 A1
(43) Pub. Date: Jun. 11, 2026

(54) BABY FOOD MAKER

(71) Applicant: Shenzhen Lute Jiacheng Supply Chain Management Co., Ltd., Shenzhen (CN)

(72) Inventors: Youxiang Ding, Shenzhen (CN); Xiaoyun Liu, Shenzhen (CN); Fan Yang, Shenzhen (CN); Jun Wang, Shenzhen (CN)

(21) Appl. No.: 19/002,795

(22) Filed: Dec. 27, 2024

(30) Foreign Application Priority Data
Dec. 10, 2024 (CN) 202423046961.4

(51) Int. Cl. A47J 43/07

(52) U.S. Cl. CPC A47J 43/0722; A47J 43/0727

(57) ABSTRACT

The present disclosure relates to the technical field of food processor and provides a baby food maker, which includes a puree-making component and a cutting component. The puree-making component includes a puree-making cup, a cover body, and a puree-making and cutting member. The puree-making cup is provided with a puree-making chamber and an opening connected to the puree-making chamber, the opening is used for food to enter and exit the puree-making chamber. The puree-making and cutting member is placed inside the puree-making chamber for cutting and making puree from food located inside the puree-making chamber. The cover body is used to close the opening. The cutting component is provided on one side of the puree-making cup where the opening is located, to cut food into pieces prior to entering into the puree-making chamber through the opening.

### CROSS-REFERENCE TO RELATED APPLICATION

The present disclosure claims priority to Chinese Patent Application No. 202423046961.4, entitled “baby food maker” filed on Dec. 10, 2024, the entire contents of which are incorporated by reference herein.

### TECHNICAL FIELD

The present disclosure relates to the technical field of food processor, and particularly to a baby food maker.

### BACKGROUND

A baby food maker is mainly used for processing foods for infants and toddlers (or infants and young children). It usually cuts and blends food into purees after steaming and cooking, or directly cuts and blends food such as fruits into purees. In specific operations, in order to facilitate the blending of food, it is usually cut into small pieces on a cutting board and then placed in a baby food maker, which increases complexities of preparing complementary food.

### SUMMARY

An objective of the present disclosure is to provide a baby food maker, which aims to solve the technical problem that existing baby food makers cannot cut food into pieces.

To achieve the above objective, the present disclosure provides a solution: a baby food maker, which includes:
A puree-making component, the puree-making component including a puree-making cup, a cover body, and a puree-making and cutting member, the puree-making cup is provided with a puree-making chamber and an opening connected to the puree-making chamber, the opening is used for food to enter and exit the puree-making chamber, the puree-making and cutting member is placed inside the puree-making chamber for cutting and making puree from food located inside the puree-making chamber. The cover body is used to close the opening; and
A cutting component, the cutting component is provided on one side of the puree-making cup where the opening is located, to cut food into pieces prior to entering into the puree-making chamber through the opening.

In one embodiment, wherein the cutting component includes a fixing member and a blade, the blade is connected to the fixing member, and the fixing member is connected to the one side of the puree-making cup where the opening is located.

In one embodiment, the fixing member is detachably connected to the puree-making cup.

In one embodiment, the cutting component includes a plurality of blades, the plurality of blades are arranged to intersect one another and are radially disposed with the intersection serving as a center; alternatively,

The plurality of blades are arranged in a crisscross pattern, forming a plurality of cutting slots arranged in an array.

In one embodiment, the baby food maker further includes a pressing component configured to apply pressure to food placed on the blades.

In one embodiment, the pressing component includes a connecting member and a pressing member;

The connecting member is connected to the cover body, and the pressing member is connected to the connecting member.

In one embodiment, the connecting member is detachably connected to the cover body;

The pressing component includes a plurality of pressing members, which are connected to the connecting member, and adjacent pressing members are formed with clearance grooves for at least partial accommodation of the blades.

In one embodiment, the baby food maker further includes a mounting member that is detachably connected to one side of the puree-making cup where the opening is located; and clearance grooves are formed between adjacent pressing members to accommodate at least a partial of the blades.

The cutting component is detachably connected to the mounting member, and the cover body is rotatably connected to the mounting member.

In one embodiment, the mounting member is configured in a ring-shaped structure, with the cutting component connected to an inner side of the mounting member, and the cover body connected to an outer side of the mounting member.

In one embodiment, the baby food maker further includes a heating component configured to heat cold water to generate water vapor, and the puree-making chamber is connected to the heating component to allow the water vapor to enter the puree-making chamber and heat food located inside the puree-making chamber.

The baby food maker provided by the present disclosure cuts food into pieces by providing the cutting component. By providing the cutting component on one side of the opening of the puree-making cup, prior to the food enters into the puree-making chamber through the opening, the food is cut into pieces by the cutting component, and then the pieces directly enter the puree-making chamber without a need for the user to manually place the pieces into the puree-making chamber. Compared to baby food makers that require a user to manual cut food into pieces on a cutting board and then transfer the pieces into the puree-making chamber, the baby food maker of the present disclosure simplifies steps of preparing complementary food, reduces redundant operations, and effectively improves the user's experience.

### BRIEF DESCRIPTION OF THE DRAWINGS

The technical solutions in the embodiments of the present disclosure will be clearly and completely described below with reference to the accompanying drawings in the embodiments of the present disclosure. Apparently, the described embodiments are only a part of the embodiments of the present disclosure but not all of them. All other embodiments obtained by a person of ordinary skill in the art based on the embodiments of present disclosure without making creative efforts shall fall within the protection scope of present disclosure.

FIG. 1 is a schematic structure diagram of a baby food maker in a state of a cover body being closed provided by a first embodiment of the present disclosure;

FIG. 2 is a schematic structure diagram of the baby food maker in a state of the cover body being opened provided by the first embodiment of the present disclosure;

FIG. 3 is a cross-sectional diagram of the baby food maker provided by the first embodiment of the present disclosure;

FIG. 4 is an exploded diagram of the baby food maker provided by the first embodiment of the present disclosure;

FIG. 5 is a schematic structure diagram of a cutting component provided by the first embodiment of the present disclosure;

FIG. 6 is an assembly structure diagram of a pressing component and the cover body provided by the first embodiment of the present disclosure;

FIG. 7 is a schematic structure diagram of a cutting component provided by a second embodiment of the present disclosure;

FIG. 8 is an assembly structure diagram of a pressing component and the cover body provided by the second embodiment of the present disclosure.

### Explanation of Figure Labels

100. Baby Food Maker; 10. Puree-Making Component; 11. Puree-Making Cup; 111. Puree-Making Chamber; 112. Opening; 1121. Cutting Slot; 12. Cover Body; 13. Puree-Making and Cutting Member; 20. Cutting Component; 21. Fixing Member; 22. Blade; 30. Pressing Component; 31. Connecting Member; 32. Pressing Member; 33. Clearance Grooves; 40. Mounting Member; 50. Heating Component.

The implementation of the purpose, functional characteristics, and advantages of the present disclosure will be further explained in conjunction with the embodiments and with reference to the accompanying drawings.

### DETAILED DESCRIPTION OF THE EMBODIMENTS

The technical solutions in the embodiments of the present disclosure are clearly and completely described below with reference to the accompanying drawings in the embodiments of the present disclosure. Apparently, the described embodiments are merely some embodiments which are a part of the present disclosure, and do not include every embodiment. All other embodiments obtained by those of ordinary skill in the art based on the embodiments of the present disclosure without creative efforts are within the scope of the present disclosure.

It should be noted that all directional indications (such as up, down, left, right, front, rear, etc.) in the embodiments of the present disclosure are only used to explain relative positional relationships and movements of various components under a specific orientation. If the specific orientation changes, the directional indications will also change accordingly.

It should also be noted that when an element is referred to as being “fixed to” or “disposed on” on another element, it can be directly on the other element or there may be intervening elements present at the same time. When an element is referred to as being “connected to” another element, it can be directly connected to other element or there may be intervening elements present at the same time.

In addition, in the embodiments of present disclosure, terms “first”, “second”, and the like are only for the purpose of description □ and should not be understood as indicating or implying relative importance or implicitly specifying a number of technical features being indicated. Therefore, features that are limited to “first” and “second” can explicitly or implicitly include at least one of the described features. Additionally, the technical solutions presented in various embodiments can be combined with each other, but must be based on what can be achieved by the person of ordinary skill in the art. When the combination of technical solutions is contradictory or impossible to achieve, it should be considered that this combination of technical solutions does not exist and is not within the protection scope required by the present disclosure.

In related technologies, baby food makers are used to steam and then cut and blend food into purees, or directly cut and blend food into purees. However, in a specific operation, food needs to be diced on a cutting board and then put into the baby food makers, which increases the complexity of baby food makers.

In view of this, the present disclosure provides a baby food maker to simplify steps of preparing complementary food, and reduce redundant operations.

### Embodiment One

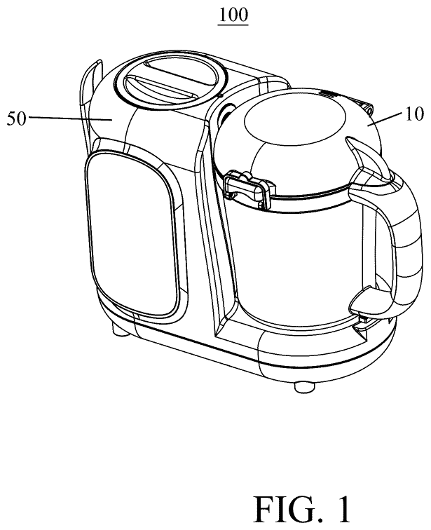

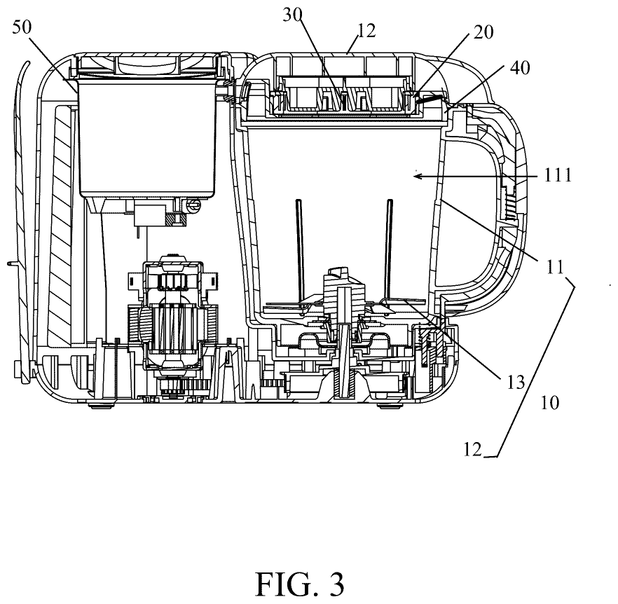

As shown in FIG. 1 to FIG. 4, a baby food maker 100 provided by the embodiment of the present disclosure includes a puree-making component 10 and a cutting component 20. The puree-making component 10 includes a puree-making cup 11, a cover body 12, and a puree-making and cutting member 13. The puree-making cup 11 is provided with a puree-making chamber 111 and an opening 112 connected to the puree-making chamber 111. The opening 112 is used for food to enter and exit the puree-making chamber 111. The puree-making and cutting member 13 is placed inside the puree-making chamber 111 for cutting and making puree from food located inside the puree-making chamber 111. The cover body 12 is used to cover the opening 112. The cutting component 20 is provided on one side of the puree-making cup 11 with the opening 112, to cut food into pieces prior to entering into puree-making chamber 111 through the opening 112.

The above technical solution, by providing the puree-making component 10, food is processed into purees. By providing the cutting component 20, food can be cut into pieces. By providing the cutting component 20 on one side of the opening 112 of the puree-making cup 11, prior to the food enters into the puree-making chamber 111 through the opening 112, the food is cut into pieces by the cutting component 20, and then the pieces directly enter the puree-making chamber 111 without a need for a user to manually place the pieces into the puree-making chamber 111. Compared to a baby food maker that requires a user to manual cut food into pieces on a cutting board and then transfer the pieces into the puree-making chamber 111, the baby food maker 100 of the present disclosure simplifies steps of preparing complementary food, reduces redundant operations, and effectively improves the user's experience.

In one embodiment, the cutting component 20 is detachably connected to one side of the puree-making cup 11 with an opening 112. In this way, the cutting component 20 can be detached from the puree-making cup 11, which is beneficial for cleaning the cutting component 20 on one hand, and allows for the use of various specifications of cutting components 20 according to different needs on the other hand.

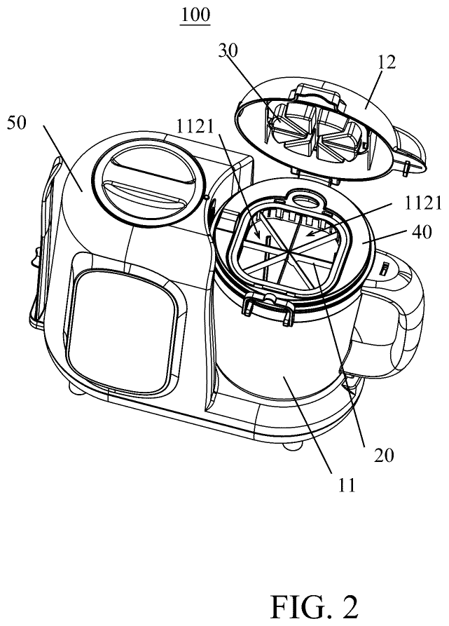

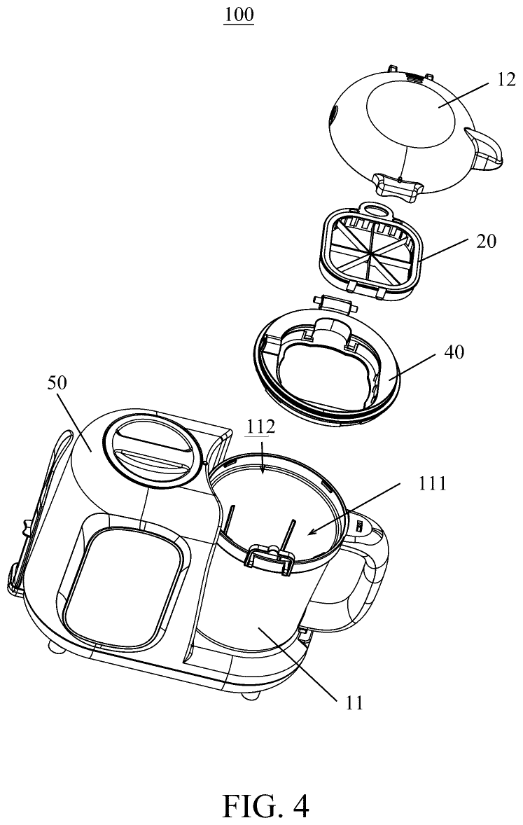

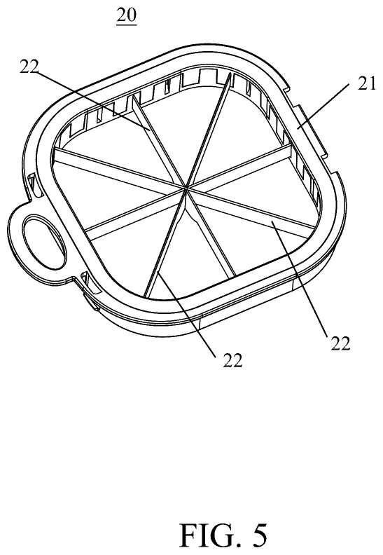

Please refer to FIG. 2, FIG. 4, and FIG. 5, the cutting component 20 includes a fixing member 21 and a blade 22. The blade 22 is connected to the fixing member 21, and the fixing member 21 is connected to the one side of the puree-making cup 11 with the opening 112. Specifically, when the fixing member 21 is connected to the puree-making cup 11, a plurality of the blades 22 are set corresponding to the opening 112, dividing the opening 112 into a plurality of cutting slots 1121. In this way, the food can be cut by the blades 22 before passing through the opening 112 into the puree-making chamber 111, and simultaneously enters into the puree-making chamber 111 through the cutting slot 1121.

In one embodiment, the fixing member 21 is detachably connected to the puree-making cup 11. Specifically, the fixing member 21 is detachably connected to one side of the puree-making cup 11 with the opening 112, so that the cutting component 20 can be detachably connected to the puree-making cup 11.

Please refer to FIG. 2 and FIG. 5, the cutting component 20 includes a plurality of blades 22, the blades 22 are arranged to intersect one another and are radially disposed with the intersection serving as a center. Wherein, the cutting slot 1121 can be fan-shaped or triangular. This design has a simple structure, easy and fast production. In this embodiment, four blades 22 are arranged to intersect. It should be noted that a number of the blades 22 is not limited by the embodiments and accompanying drawings, and different quantities can be set according to needs. It should also be noted that an arrangement of the blades 22 can be set according to needs, and the embodiment does not limit the arrangement of the blades 22.

Please refer to FIG. 2, FIG. 4, and FIG. 5, the baby food maker 100 also includes a pressing component 30, which is configured to apply pressure to food placed on the blades 22. In a specific embodiment, the food to be cut into pieces is placed on the blades 22, and pressed by the pressing component 30. The food moves downward and enters into the puree-making chamber 111 through the cutting slot 1121 under the cutting of the plurality of blades 22. Of course, in other embodiments, the baby food maker 100 may not be provided the pressing component 30. When using this technical solution, the user can directly press the food or use other tools to press the food.

In one embodiment, the pressing component 30 is detachably connected to the cover body 12. With this arrangement, when connecting the pressing component 30 to the cover body 12, a number of parts in the baby food maker 100 can be reduced, avoiding excessive space occupation due to too many parts. At the same time, by closing the opening 112 through the cover body 12, it is possible to press the food located on the cutting component 20. When separating the pressing component 30 from the cover body 12, it is beneficial for cleaning the pressing component 30. Furthermore, when replacing the cutting component 20 with a different specification, the pressing component 30 can be replaced accordingly to match the new pressing component.

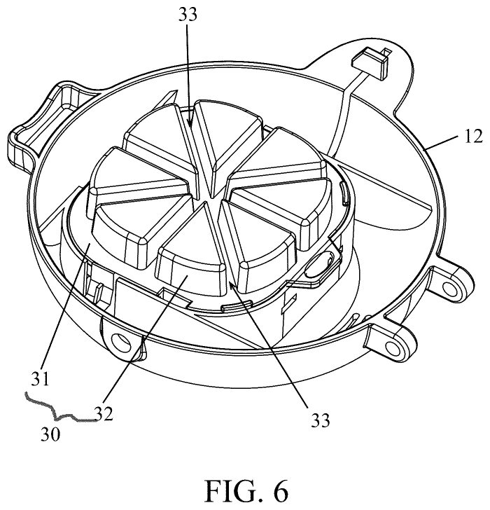

Please refer to FIG. 2, and FIG. 4 to FIG. 6, the pressing component 30 includes a connecting member 31 and a pressing member 32. The connecting member 31 is connected to the cover body 12, and the pressing member 32 is connected to the connecting member 31. By setting the pressing member 32 to pass through the cutting slot 1121 when pressing down on the food, it ensures that the food can enter the puree-making chamber 111 through the cutting slot 1121 after being cut into pieces. In a specific embodiment, each pressing member 32 presses down on the food so that a portion of the food corresponding to the cutting slot 1121 can pass through the cutting slot 1121 and enter into the puree-making chamber 111, while a portion of the food corresponding to the blades 22 can be cut by the blades 22.

In one embodiment, the connecting member 31 is detachably connected to the cover body 12. In this way, the pressing component 30 can be detachably connected to the cover body 12.

In one embodiment, the pressing component 30 includes a plurality of the pressing members 32, which are connected to the connecting member 31. Adjacent pressing members 32 are formed with clearance grooves 33 for at least partial accommodation of the blades 22. Wherein, each pressing member 32 corresponds to one cutting slot 1121. In a specific embodiment, each pressing member 32 presses down on the food and passes through the corresponding cutting slot 1121 during a cutting process, so that the portion of the food corresponding to the cutting slot 1121 can enter into the puree-making chamber 111 through the cutting slot 1121, while the blades 22 are inserted into the clearance grooves 33 during the cutting process. In one embodiment, the connecting member 31 and the pressing members 32 are integrally formed. This configuration can eliminate a need for assembling the connecting member 31 and the pressing members 32, and improve connection firmness between the connecting member 31 and the pressing member 32.

In one embodiment, a cross-section area of the pressing member 32 is smaller than a cross-section area of the corresponding cutting slot 1121. This ensures that when the pressing member 32 passes through the cutting slot 1121, a side wall of the cutting slot 1121 will not obstruct the pressing member 32, so that the pressing member 32 can freely pass through the corresponding cutting slot 1121.

In one embodiment, a shape of the pressing member 32 is identical to that of the corresponding cutting slot 1121. This configuration is beneficial for the pressing member 32 to press the portion of the food corresponding to the cutting slot 1121 into the cutting slot 1121. Of course, in other embodiments, it is also possible for the shape of the pressing member 32 to be different from that of the corresponding cutting slot 1121.

Please refer to FIG. 4, the baby food maker 100 also includes a mounting member 40, which is detachably connected to one side of the puree-making cup 11 with the opening 112, and the cutting component 20 is detachably connected to the mounting member 40. In this way, the cutting component 20 can be detachably connected to the puree-making cup 11. Of course, in specific applications, as an alternative embodiment, it is also possible for the baby food maker 100 to not be equipped with the mounting member 40. When using this technical solution, the cutting component 20 can be directly and detachably connected to the puree-making cup 11.

In one embodiment, the cover body 12 is rotatably connected to the mounting member 40. In a specific embodiment, when the mounting member 40 is detached from the puree-making cup 11, it can drive the cover body 12 to separate from the puree-making cup 11. On one hand, this separates the cover body 12 from the puree-making cup 11, which is beneficial for cleaning the puree-making cup 11. On the other hand, connecting the cover body 12 and the mounting member 40 to each other after detaching them from the puree-making cup 11 can reduce a number of scattered parts after disassembly, thereby preventing issues such as loss or excessive space occupation due to too many parts. Of course, in other embodiments, the cover body 12 can be detachably connected to both the mounting member 40 and the puree-making cup 11, or the cover body 12 can be detachably connected to the puree-making cup 11.

In one embodiment, the mounting member 40 has a ring-shaped structure, with the cutting component 20 connected to an inner side of the mounting member 40, and the cover body 12 connected to an outer side of the mounting member 40.

In one embodiment, the mounting member 40 adopts a ring-shaped structure, and the cutting component 20 is arranged along a radial direction of the mounting component 40, away from a part of the mounting member 40 that connects to the cover body 12. Due to the pressing member 32 protrudes from the cover body 12, by arranging the cutting component 20 along the radial direction of the mounting component 40, away from the part of the mounting member 40 that connects to the cover body 12, even if the cutting component 20 is arranged away from a rotation center of the cover body 12, there is enough space for the pressing member 32 to extend into the cutting slot 1121 when the cover body 12 rotates relative to the mounting member 40. Of course, in other embodiments, it is also possible for the cutting component 20 to be connected to a central part of the mounting member 40.

In one embodiment, the mounting member 40 is tilted on one side of the puree-making cup 11 with the opening 112, so that the cutting component 20 is tilted. By tilting both the mounting member 40 and the cutting component 20 at a certain angle, it is more in line with ergonomics and more suitable for users to press the cover body 12 to press down on food, making it more effortless for users. Of course, in other embodiments, it is also possible to arrange both the mounting member 40 and the cutting component 20 horizontally.

Please refer to FIG. 4, the baby food maker 100 also includes a heating component 50, which is configured to heat cold water to generate water vapor. The puree-making chamber 111 is connected to the heating component 50, so that the water vapor can enter the puree-making chamber 111 and heat the food located inside the puree-making chamber 111. In this way, the baby food maker 100 can steam and cook food, turning raw food into cooked food. Therefore, the baby food maker 100 can not only puree food that does not require steaming and cooking (such as fruits) but also puree food that needs to be steamed and cooked (such as vegetables), thereby expanding a scope of use of the baby food maker 100.

In a specific embodiment, the food is placed on the cutting component 20 and the cover body 12 is then covered. As the cover body 12 closes, the food is cut into pieces by the cutting component 20 and enters into the puree-making chamber 111. The heating component 50 is activated to heat the cold water and generate the water vapor. The water vapor enters the puree-making chamber 111 from the heating component 50 to steam the pieces. After steaming and cooking, the puree-making and cutting member 13 is driven to rotate, and the pieces is made into puree like food. The operation process is all carried out inside the baby food maker 100, without the need to cut the food into pieces on the cutting board and then put it into the baby food maker 100, making the operation more convenient and faster.

### Embodiment Two

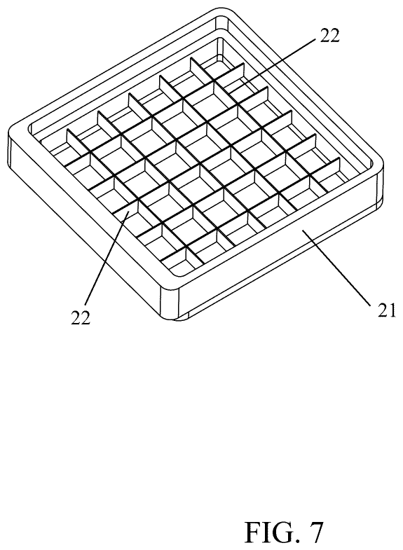

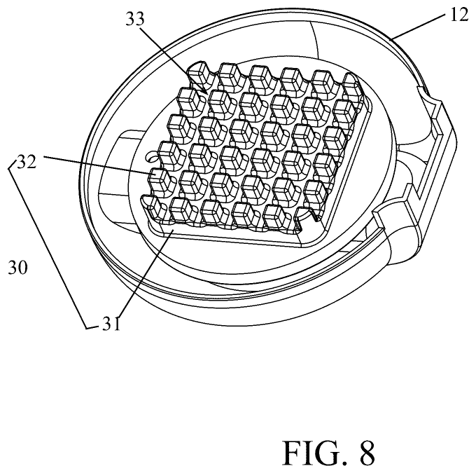

Please refer to FIG. 2, and FIG. 5 to FIG. 8, a difference between the baby food maker 100 provided in this embodiment and Embodiment one is the arrangement of the blades 22. Specifically, the plurality of blades 22 are arranged to intersect one another in Embodiment one; whereas in this embodiment, the blades 22 are arranged in a crisscross pattern.

The arrangement of the blades 22 is different, the shapes and the arrangements of the cutting slots 1121 formed are also different. In this embodiment, the plurality of blades 22 are arranged in a crisscross pattern, forming a plurality of cutting slots 1121 arranged in an array. This design has a simple structure, easy and fast production. Specifically, five blades 22 are set vertically and horizontally. It should be noted that a number of the blades 22 set vertically and horizontally is not limited by the embodiments and accompanying drawings, and can be set according to different requirements. The number of the blades 22 set vertically and horizontally can be the same or different. In addition, the shape and arrangement of the pressing member 32 can be designed according to the shape and arrangement of the cutting slot 1121.

In addition to the above differences, the baby food maker 100 and its accessory components provided in this embodiment can be designed with reference to Embodiment one and will not be described here.

The above description is only a preferred embodiment of the present disclosure and does not limit the patent scope of the present disclosure. Any equivalent structural transformation made using contents of the specification and accompanying drawings of the present disclosure, under the inventive concept of the present disclosure, or directly/indirectly applied in other related technical fields, is included in the patent protection scope of the present disclosure.

What is claimed is:

1. A baby food maker, comprising:
a puree-making component, wherein the puree-making component comprises a puree-making cup, a cover body, and a puree-making and cutting member, the puree-making cup is provided with a puree-making chamber and an opening connected to the puree-making chamber, the opening is used for food to enter and exit the puree-making chamber, the puree-making and cutting member is placed inside the puree-making chamber for cutting and making puree from food located inside the puree-making chamber, the cover body is used to close the opening; and
a cutting component, wherein the cutting component is provided on one side of the puree-making cup where the opening is located, to cut food into pieces prior to entering into the puree-making chamber through the opening.

2. The baby food maker according to claim 1, wherein the cutting component comprises a fixing member and a blade, the blade is connected to the fixing member, and the fixing member is connected to the one side of the puree-making cup where the opening is located.

3. The baby food maker according to claim 2, wherein the fixing member is detachably connected to the puree-making cup.

4. The baby food maker according to claim 2, wherein the cutting component comprises a plurality of blades, the plurality of blades are arranged to intersect one another and are radially disposed with the intersection serving as a center; or
the plurality of blades are arranged in a crisscross pattern, forming a plurality of cutting slots arranged in an array.

5. The baby food maker according to claim 2, further comprising a pressing component configured to apply pressure to food placed on the blades.

6. The baby food maker according to claim 5, wherein the pressing component comprises a connecting member and a pressing member;
the connecting member is connected to the cover body, and the pressing member is connected to the connecting member.

7. The baby food maker according to claim 6, wherein the connecting member is detachably connected to the cover body;
the pressing component comprises a plurality of pressing members, which are connected to the connecting member, and adjacent pressing members are formed with clearance grooves for at least partial accommodation of the blades.

8. The baby food maker according to claim 1, further comprising a mounting member that is detachably connected to one side of the puree-making cup where the opening is located; and clearance grooves are formed between adjacent pressing members to accommodate at least a partial of the blades;
the cutting component is detachably connected to the mounting member, and the cover body is rotatably connected to the mounting member.

9. The baby food maker according to claim 8, wherein the mounting member is configured in a ring-shaped structure, with the cutting component connected to an inner side of the mounting member, and the cover body connected to an outer side of the mounting member.

10. The baby food maker according to claim 1, further comprising a heating component configured to heat cold water to generate water vapor, and the puree-making chamber is connected to the heating component to allow the water vapor to enter the puree-making chamber and heat food located inside the puree-making chamber.
